(19) United States
(12) Patent Application Publication
(10) Pub. No.: US 2009/0000455 A1
(43) Pub. Date: Jan. 1, 2009

(54) REINFORCING DEVICE FOR A MAIN BODY OF A BAND SAW

(76) Inventor: Chin-Feng CHANG, Feng Yuan City (TW)

Correspondence Address: SINORICA, LLC, 528 FALLSGROVE DRIVE, ROCKVILLE, MD, 20850, US

(21) Appl. No.: 11/770,765

(22) Filed: Jun. 29, 2007

(51) Int. Cl. B26D 1/00

(52) U.S. Cl. 83/859

(57) ABSTRACT

The invention relates to a reinforcing device of a main body of a band saw. The main body at least includes a vertical column, two (upper and lower) frames and a base. The upper frame has a connecting plate formed at its bottom with a connecting portion. The vertical column is bored with a working hole to c or r e s pond to the connecting portion, for b e in g inserted with a reinforcing element fixed in a certain angle. The reinforcing element has it s one end resting and welded on an inner surface of the vertical column, and the other side welded above the connecting portion of the upper frame, so as to augment the strength of the upper frame while fixed at an upper portion of the vertical column.

### BACKGROUND OF THE INVENTION

1. Field of the invention

This invention relates to a band saw, particularly to one having a reinforcing device to strengthen its main body.

2. Description of the Prior Art

As shown in FIG. 1, a first conventional band saw 10 at least consists of a vertical column 11, an upper frame 12 and a lower frame 13 formed hollow, and a base 14. The frames 12 and 13 are respectively provided with a connecting portion 121 and 131 welded with the vertical column 11. In operation, when a saw belt 17 is tightly straightened, an upper belt wheel 15 and a lower belt wheel 16 may be drawn toward each other to enable the frames 12 and 13 deformed, posing a displacement of the saw band 17 to lower precision of a processed workpiece. Therefore, some manufacturers additionally install a triangular reinforcing block 18 between the connection portion 121 and the vertical column 11 to augment the strength of the upper frame 12. However, such an additional reinforcement, only keeping the reinforcing block 18 welded on the surface of the vertical column 11, is still not strong enough to prevent the upper frame 12 from deforming. Moreover, the reinforcing block 18 not only increases burden to the upper frame 12, but also relatively lessen space for other components, possible to be inconvenient for a user to operate.

A second conventional band saw 20, shown in FIG. 2, at least includes a vertical column 21, an upper frame 22 and a lower frame 23 formed hollow, and a base 24. In order to strengthen the upper frame 22, some manufacturers add a reinforcing tube 25 connected outwards at the bottom of the upper frame 22 and horizontally fixed on the vertical column 21. But, with the reinforcing tube 25 extended outside the upper frame 22, the band saw 20 looks not so harmonious. And, like the first conventional band saw 10, the reinforced tube 25 is also merely welded on the surface of the vertical column 21, so the upper frame 22 is not only unable to withstand deformation, but to just increase its weight as well.

### SUMMARY OF THE INVENTION

The objective of this invention is to offer a reinforcing device for a main body of a band saw.

The main characteristics of the invention are two reinforcing elements and two enclosing elements. The main body at least includes a vertical column, two (upper and lower) frames and a base. The vertical column is provided with a working hole bored at a location corresponding to the upper frame for the reinforcing element to pass through and be welded, so as to rev up the strength of the upper frame while fixed on the vertical column, thus preventing the upper frame from deformed and upgrading precision while sawing. As the reinforcing element is a flat plate, it not only does not add too much weight on the upper frame, but also neither occupy too much space to obstruct installation of other components in the upper frame.

### BRIEF DESCRIPTION OF DRAWINGS

This invention is better understood by referring to the accompanying drawings, wherein:

FIG. 1 is a perspective view of a first conventional reinforcing device for a main body of a band saw;

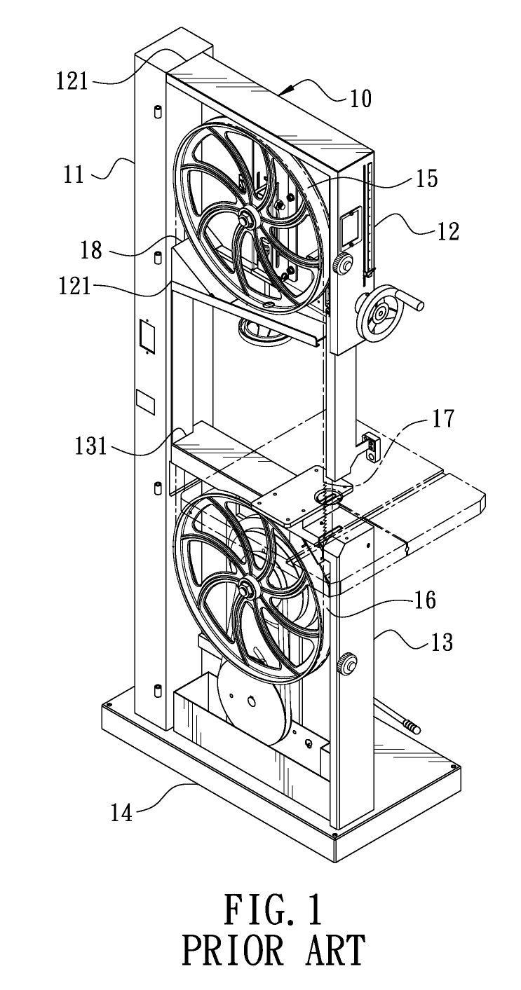

FIG. 2 is a perspective view of a second conventional reinforcing device for a main body of a band saw;

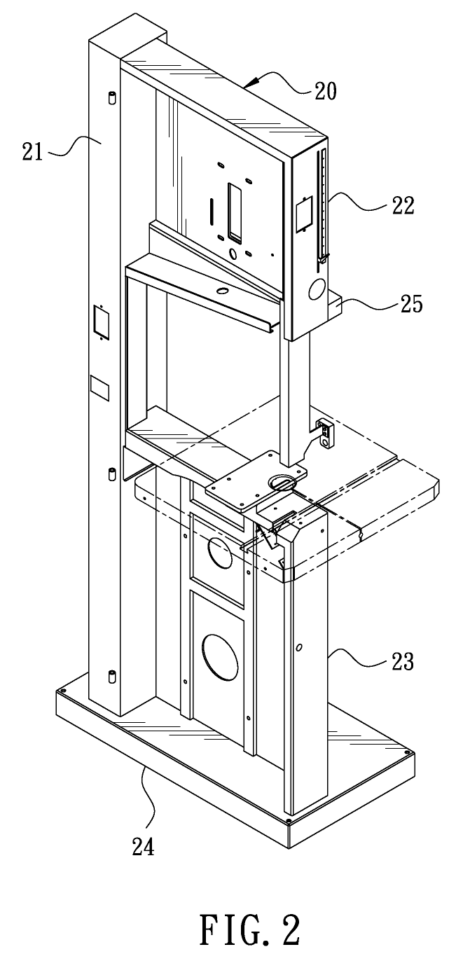

FIG. 3 is a perspective view of a first preferred embodiment of a reinforcing device for a main body of a band saw in the present invention;

FIG. 4 is an exploded perspective view of the first preferred embodiment of a reinforcing device for a main body of a band saw in the present invention;

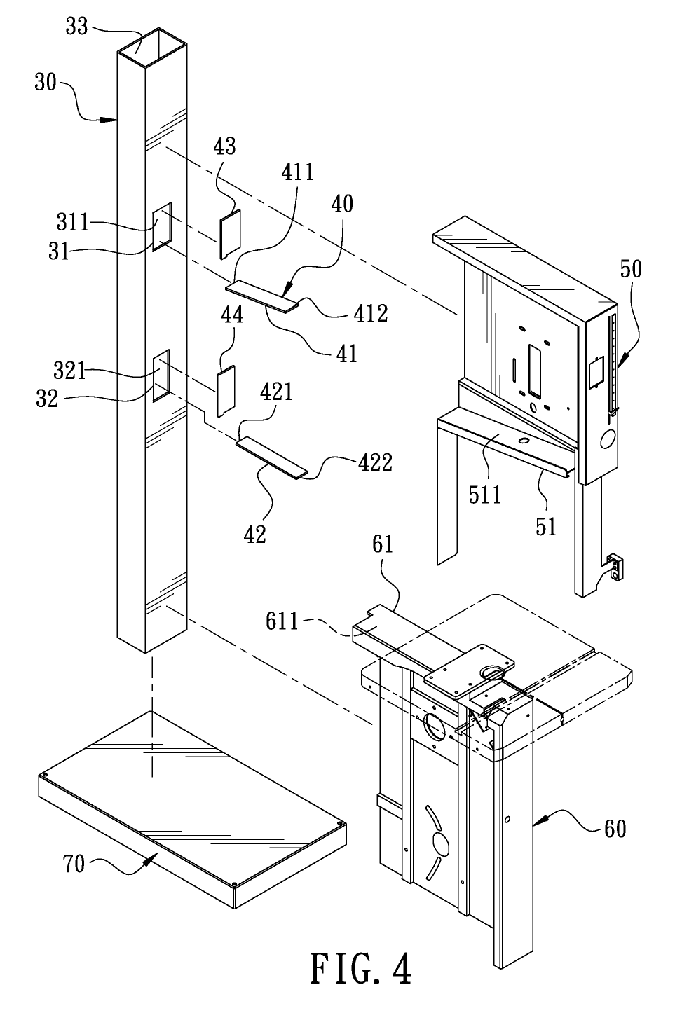

FIG. 5 is a cross-sectional view of the first preferred embodiment of a reinforcing device for a main body of a band saw in the present invention;

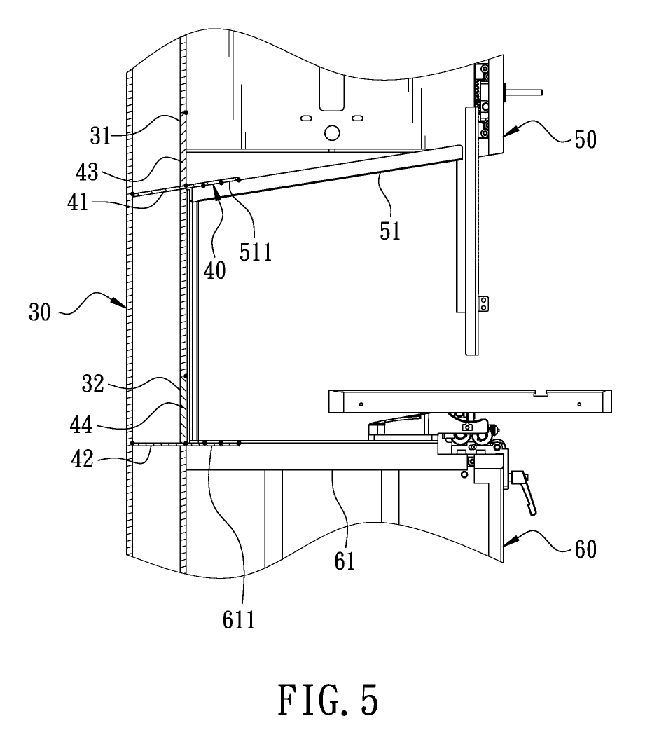

FIG. 6 is a partial perspective view of the first preferred embodiment of a reinforcing device for a main body of a band saw in the present invention, showing its upper frame;

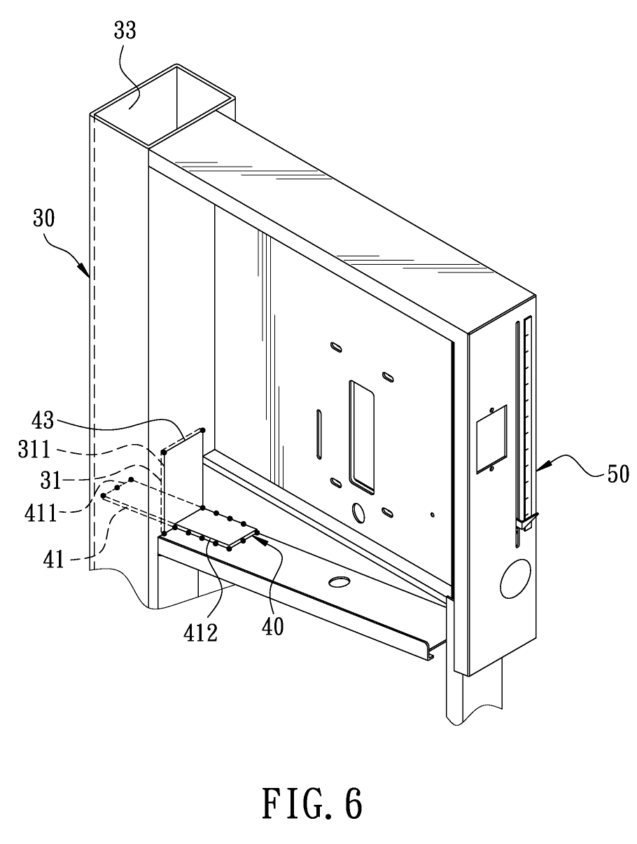

FIG. 7 is a partial perspective view of the first preferred embodiment of a reinforcing device for a main body of a band saw in the present invention, showing its lower frame;

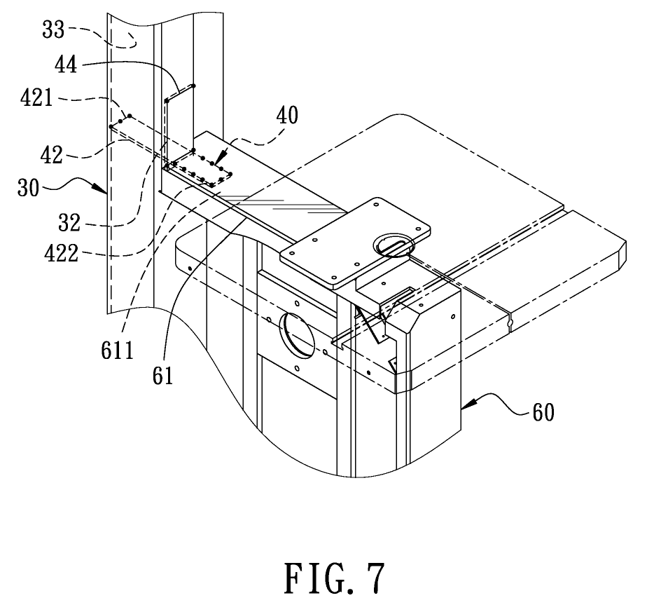

FIG. 8 is a perspective view of a second preferred embodiment of a reinforcing device for a main body of a band saw in the present invention;

FIG. 9 is a partial perspective view of a third preferred embodiment of a reinforcing device for a main body of a band saw in the present invention, showing its upper frame;

FIG. 10 is a partial perspective view of a fourth preferred embodiment of a reinforcing device for a main body of a band saw in the present invention, showing its upper frame; and

FIG. 11 is a partial perspective view of a fifth preferred embodiment of a reinforcing device for a main body of a band saw in the present invention, showing its upper frame.

### DETAILED DESCRIPTION OF THE PREFERRED EMBODIMENT

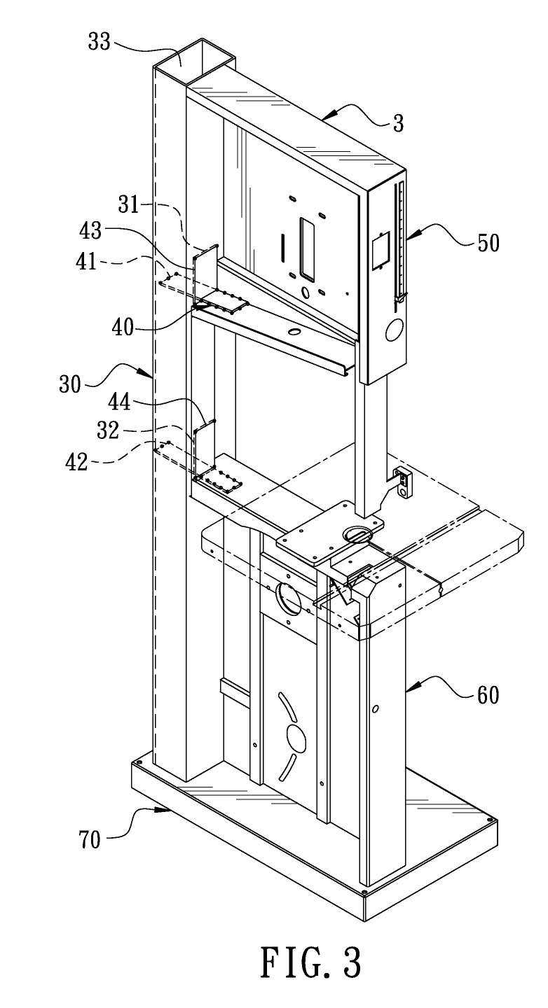

FIGS. 3˜7 show a preferred embodiment of a reinforcing device for a main body 3 of a band saw in the present invention. The main body 3 is at least composed of a vertical column 30, a reinforcing device 40, an upper frame 50 and a lower frame 60 formed hollow, and a base 70.

The vertical column 30 is shaped as a rectangular hollow column, provided with an upper working hole 31 and a lower working hole 32 respectively bored at a preset location slightly higher and lower than its center with a certain size. Inside the vertical column 30 is a fixing surface 33, corresponding to the upper working hole 31 and the lower working hole 32.

The reinforcing device 40 includes two (upper and lower) reinforcing elements 43 and 44 formed as a planar plate, and two (upper and lower) enclosing elements 43 and 44. The reinforcing elements 41 and 42 are made of metal plate, inserted through the working holes 31 and 32 respectively. The reinforcing elements 41 and 42 are respectively provided with an entering end 411 and 421 for being inserted through the working holes 31 and 32 to be welded on the fixing surface 33, and a connecting end 412 and 422 located at the other side. The enclosing elements 43 and 44 are made of steel plates having a size and a shape coincident with openings 311 and 321 of the working holes 31 and 32 after having the reinforcing elements 41 and 42 inserted in the working holes 31 and 32. Thus, the enclosing elements 43 and 44 can be just fitted and welded on the openings 311 and 321, so that the sawdust can be totally prevented from dropping into the working holes 31 and 32 while sawing a workpiece.

The frames 50 and 60 respectively have one side fixed at an upper and a lower position of the vertical column 30. The upper frame 50 is provided with an inclined connecting plate 51 located at its bottom side. The connecting plate 51 has a connecting portion 511 formed in its inner surface for the reinforcing element 41 to rest on and pass through the upper working hole 31, so as to keep the connecting side 412 of the reinforcing element 41 positioned on the connecting portion 511. The circumference of the contact are a between the connecting portion 511 and the lower surface of the connecting portion 412 is welded together. The lower frame 60 is provided with a connecting plate 61 located at its upper side. The connecting plate 61 has a connecting portion 611 formed on its top for the connecting portion 421 of the reinforcing element 42 to be welded under the connecting portion 611.

The base 70 is fixed at the bottom of the vertical column 30 and the lower frame 60, used as a stand for the main body.

It is noted that the reinforcing elements 41 and 42 have a width of 38 mm, a thickness of 6 mm, and a certain length. The connecting portions 412 and 422 are extended out of the working holes 31 and 32 with a length of 65 mm˜70 mm, so as to have sufficient strength to prevent the frames 50 and 60 from deformed during operation.

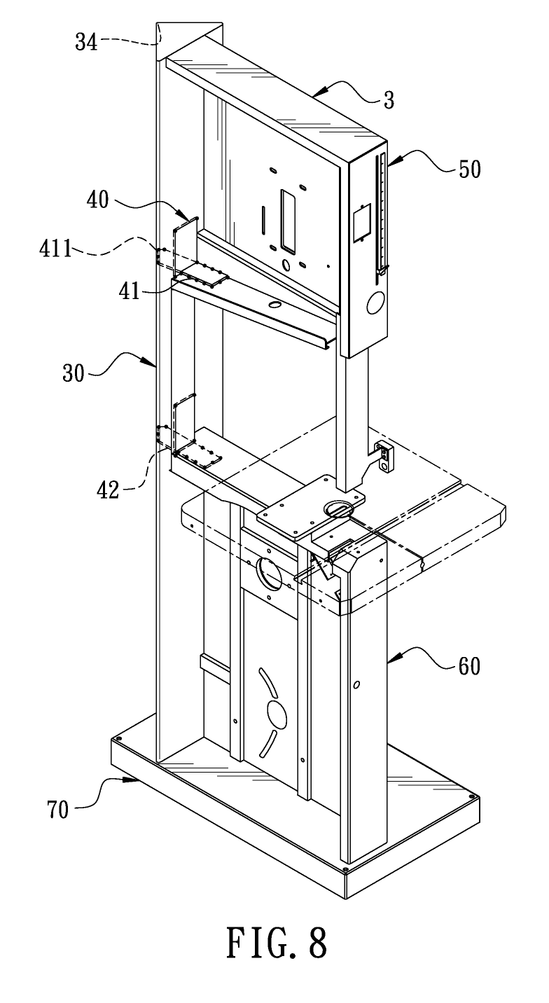

As shown in FIG. 8, a second preferred embodiment of a reinforcing device for a main body 3 of a band saw in the present invention has the same components as the first one does, except that the vertical column 30 is formed triangular. Inside the vertical column 30, corresponding to the upper working hole 31 is a fixing surface 34 shaped as an arc that is also coincident to that of the entering head 4 11 of the reinforcing element 41, so that the entering end 411 can contact closely with and then fixedly welded on the fixing surface 34.

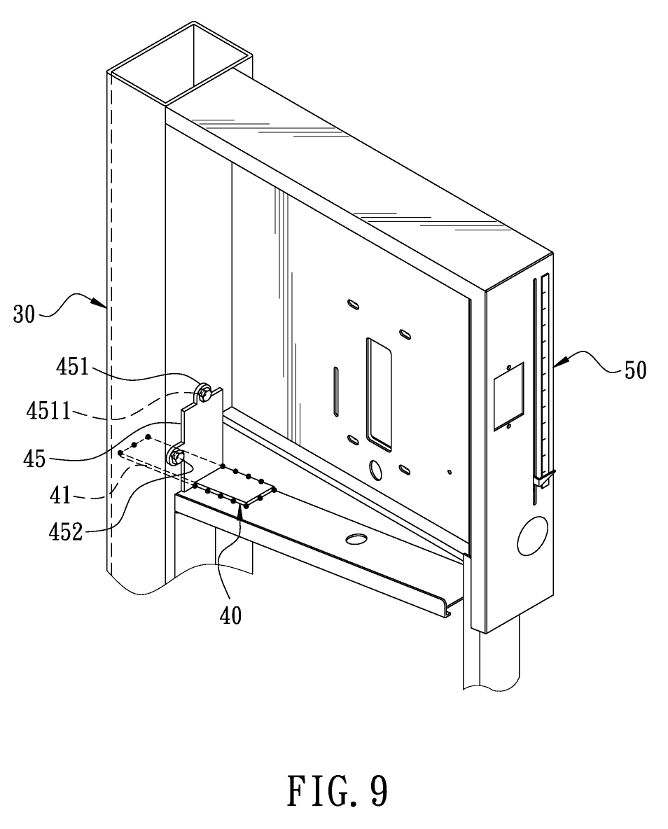

As shown in FIG. 9, a third preferred embodiment of a reinforcing device for a main body 3 of a band saw in the present invention has the same components as the first one does, except that the upper enclosing element 45 is made of a plastic board. The enclosing element 45 is provided with a projection 451 extended at its two adjacent sides respectively. Each of the projections 451 is bored with a positioning hole 4511 for a screw 452 to engage to keep the opening 311 sealed by the upper enclosing element 45.

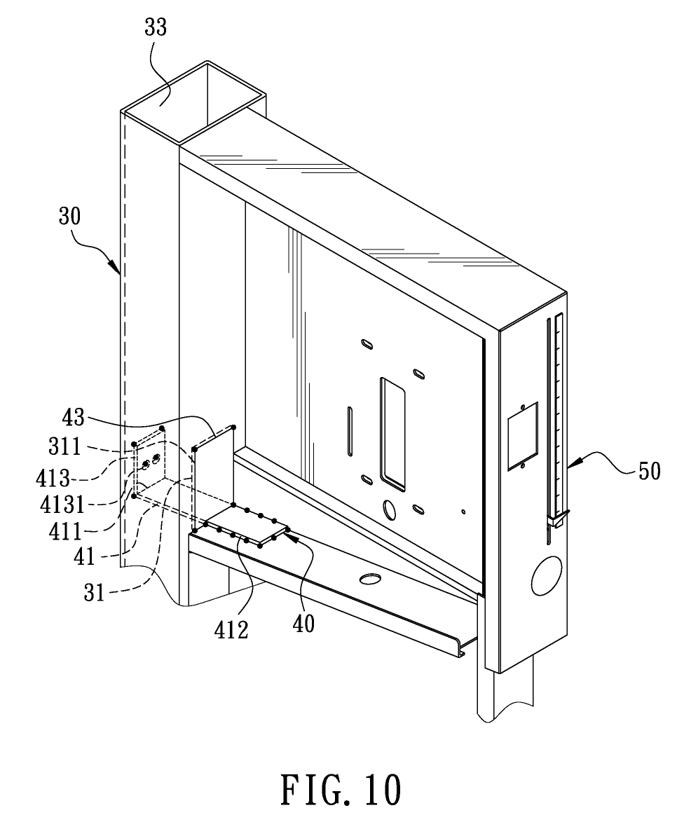

As shown in FIG. 10, a fourth preferred embodiment of a reinforcing device for a main body 3 of a band saw in the present invention has the same components as the first one does, except that the entering end 411 of the upper reinforcing element 41 is vertically extended with a restricting portion 413 bored with two welding holes 4131 horizontally spaced apart at its center, so that the restricting portion 413 can be fixed on the fixing surface 33 of the vertical column 30 by welding at the welding holes 4131 and around the circumference of the restricting portion 413.

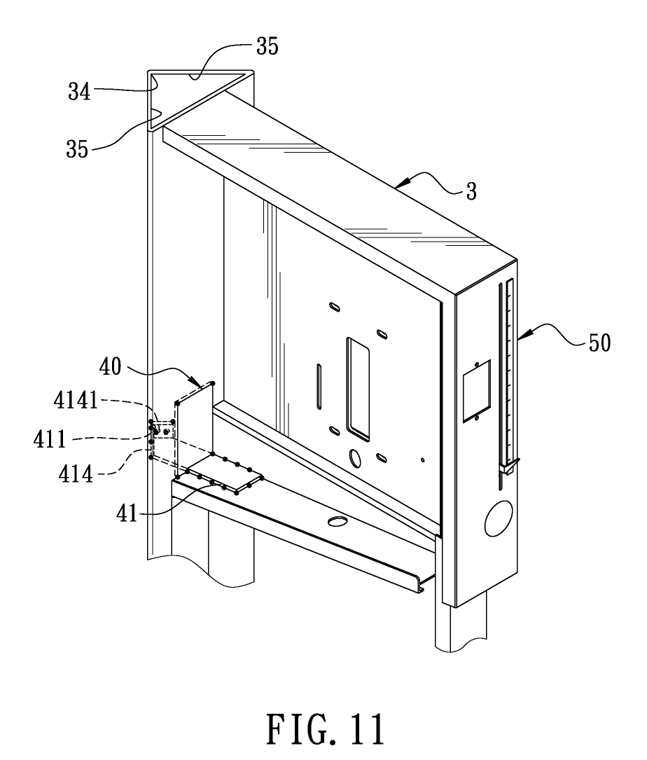

As shown in FIG. 11, a fifth preferred embodiment of a reinforcing device for a main body 3 of a band saw in the present invention has the same components as the second one does, except that two sides of the fixing surface 34 of the vertical column 30 are respectively formed as a restricting surface 35 And, two sides of the entering head 411 are respectively extended vertically with a restricting portion 414, which is bored with two welding holes 4141 horizontally spaced apart at its center. Via welding around the circumference of the restricting portion 414 and in the welding holes 4141, the entering end 411 and restricting portion 414 can be fixedly welded on the fixing surface 34 and the restricting surfaces 35.

The advantages of the invention are described below as can be seen from the foresaid description.

With the entering ends 411 and 421 of the reinforcing elements 41 and 42 welded on the fixing surface 33 and the connecting portions 412 and 422 welded with the frames 50 and 60, the frames 50 and 60 can be reinforced with sufficient strength to prevent them from deformed while operating the belt saw in the present invention, assuring sawing efficiency and precision. As the reinforcing elements 41 and 42 are just steel plates, they don't add too much extra weight on the frames 50 and 60. Moreover, the reinforcing elements 41 and 42 have a rather small size and a smooth shape, so they just occupy minimum space without obstructing installation of other components in the frames 50 and 60.

While the preferred embodiment of the invention has been described above, it will be recognized and understood that various modifications may be made therein and the appended claims are intended to cover all such modifications that may fall within the spirit and scope of the invention.

What is claimed is:

1. A reinforcing device for a main body of a band saw, said band saw at least comprising a vertical column, an upper frame and a lower frame formed hollow, and a base, said upper frame and said lower frame respectively having its one side fixed at an upper and a lower portion of said vertical column, said vertical column standing on said base, said upper frame having a connecting plate at its bottom side; and.
characterized by said connecting plate of said upper frame provided with a connecting portion, said vertical column provided with at least a working hole bored at a location corresponding to one side of said connecting portion, said working hole inserted with a reinforcing element fixed in a certain angle, said reinforcing element provided with an entering end inserted through said working hole and a connecting end formed at another side, said entering end resting and welded on an inner surface of said vertical column, said connecting end of said reinforcing element contacting with said connecting portion of said upper frame and having its circumference contacting with said connecting portion of said upper frame welded, thus said upper frame able to be augmented with its strength while fixed at one side of said vertical column.

2. The reinforcing device for a main body of a band saw as claimed in claim 1, wherein said working hole after being inserted with said reinforcing element is formed as an opening that is sealed by an enclosing element with an equivalent size.

3. The reinforcing device for a main body of a band saw as claimed in claim 2, wherein said enclosing element is made of a steel plate that is welded with said vertical column around its circumference after fitted in said opening.

4. The reinforcing device for a main body of a band saw as claimed in claim 2, wherein said enclosing element is made of a plastic board and provided with a projection extended at its two adjacent sides respectively, each of said projections bored with a positioning hole for being fixed with a screw to keep said enclosing element covered on said opening.

5. The reinforcing device for a main body of a band saw as claimed in claim 1, wherein said reinforcing element is made of a steel plate.

6. The reinforcing device for a main body of a band saw as claimed in claim 1, wherein said lower frame is provided with a connecting plate formed at its upper side, said connecting plate having a connecting portion on its top surface, said vertical column provided with a working hole bored at a location corresponding to one side of said connecting portion of said lower frame for an entering end of another reinforcing element to pass through and be welded, said connecting portion of said reinforcing element rested under said connecting portion of said lower frame and having its circumference contacting with said connecting portion of said lower frame welded, thus said lower frame able to be reinforced with its strength while fixed at one side of said vertical column.

7. The reinforcing device for a main body of a band saw as claimed in claim 1, wherein said entering end of said reinforcing element is vertically extended with a restricting portion bored with two welding holes horizontally spaced apart at its center, so that said restricting portion can be fixed on said vertical column by welding at said welding holes and around a circumference of said restricting portion.
